(19) United States
(12) Patent Application Publication
(10) Pub. No.: US 2002/0160810 A1
(43) Pub. Date: Oct. 31, 2002

(54) Intelligent network service control point and method of implementing user services utilizing call processing language scripts

(75) Inventors: Roch Glitho, Montreal (CA); Christophe Gourraud, Montreal (CA)

Correspondence Address: Steven W. Smith, SMITH, DANAMRAJ & YOUST, P.C., Suite 1200, LB-5, 12900 Preston Road, Dallas, TX, 75230-1328, US

(73) Assignee: Telefonaktiebolaget LM Ericsson (publ)

(21) Appl. No.: 09/805,657

(22) Filed: Mar. 14, 2001

(51) Int. Cl. H04B 1/38

(52) U.S. Cl. 455/560; 455/445; 455/433

(57) ABSTRACT

An Intelligent Network Service Control Point (IN-SCP) and method of implementing user services in a telecommunications network utilizing user-defined Call Processing Language (CPL) scripts. The IN-SCP stores at least one CPL script that provides a first service when the script is executed. The IN-SCP includes a CPL script interpreter for mapping semantics of the CPL script to IN procedural detection points. When the IN-SCP receives a service trigger from a call server such as a Mobile Switching Center (MSC), the IN-SCP executes the CPL script. If the user also subscribes to service provider-defined IN services, the IN-SCP executes the service provider-defined IN services first, and then executes the CPL script after determining that the script is consistent with the IN services.

### BACKGROUND OF THE INVENTION

1. Technical Field of the Invention

This invention relates to telecommunication systems and, more particularly, to an Intelligent Network Service Control Point (IN-SCP) and a method of implementing user services utilizing Call Processing Language (CPL) scripts.

Description of Related Art

2. In telecommunication systems today, there are two distinct technologies in use—legacy circuit-switched telecommunications networks and packet-switched networks such as the Internet. In legacy circuit-switched networks, the Intelligent Network (IN) architecture, in which subscriber services are stored as service logics in a service node, is the preferred way to provide enhanced subscriber services. The term “IN”, as used herein, includes all types of IN networks such as Fixed IN, Advanced Intelligence Network (AIN), Camel for the Global System for Mobile Communications (GSM), and Wireless Intelligent Network (WIN) for Time Division Multiple Access (TDMA) networks. IN services are defined by the service provider who loads the service logics into a service logic database in a service node such as a Service Control Point (SCP). Complex services can be defined using IN service logic (e.g., different actions depending on varying conditions specified in the logic). For example, different actions may be taken for calls from different numbers, calls from different locations, calls that depend on the location of the user, calls at different times of the day or day of the week, prepaid calls, etc. Thus, IN is a very powerful service provisioning system. A disadvantage of IN, however, is that the end user does not have the freedom to define his own services. The services must be defined by the service provider, and the end user is charged for the services provided.

In the Internet domain, the Internet Engineering Task Force (IETF) has designated the Session Initiation Protocol (SIP) as the preferred way to provide access to multi-media and conventional subscriber services for Internet telephony. In addition, the Third Generation Partnership Project (3GPP) has selected SIP as the preferred technology over the International Telecommunications Union, Telecommunications Sector (ITU-T) H.323 protocol as the basis for the next generation of combined networks. Within the SIP architecture there are several mechanisms for the creation of user services in the packet-switched domain such as the Common Gateway Interface (CGI) and Call Processing Language (CPL). CGI provides a flexible, general purpose mechanism targeted at service providers, and CPL provides a simpler, more restricted mechanism targeted at end users.

CPL is a protocol-independent language based on the Extended Markup Language (XML). It enables end users to define their own services which are provided through CPL scripts. Users can write scripts in CPL using a flexible text-based syntax or graphical tools which collect user preferences in a user-friendly manner. These scripts can then be uploaded to the service provider and automatically placed in the packet network. This makes the service instantly available. CPL is protocol-independent because it abstracts the operation of the protocol to providing a basic set of services and being able to generate a basic set of information. CPL contains primitives which cause various messages to be sent, and those primitives return results based on the protocol message exchanges. Disadvantages of CPL, however, include the fact that the scripts are limited to fairly simple originating or terminating services, and the language is defined for use only in the Internet domain. According to the IETF, CPL scripts are not supposed to co-exist with services implemented by other means. Additionally, only one CPL script can be used for each incoming or outgoing call, while several independent IN services can be combined for a particular call. Consequently, CPL scripts are less powerful than IN.

It would be advantageous to have an IN-SCP in which certain subscriber services are implemented in CPL scripts. This would provide end users with the power of IN services along with the freedom to define some of their own call setup services through CPL scripts. In addition, services defined by CPL scripts could be executed in the legacy circuit-switched domain. The present invention provides such an IN-SCP.

### SUMMARY OF THE INVENTION

In one aspect, the present invention is an Intelligent Network Service Control Point (IN-SCP) for providing services to users in a telecommunications network. The IN-SCP comprises at least one Call Processing Language (CPL) script that generates a call-control instruction when the script is executed, and means for executing the CPL script in response to receiving a service trigger for the script. The IN-SCP may also include a CPL script interpreter for mapping semantics of the CPL script to IN procedural detection points. If the user also subscribes to service provider-defined IN services, the IN-SCP executes the service provider-defined IN services first, and then executes the CPL script.

In another aspect, the present invention is a system in a telecommunications network for providing services to users. The system includes an IN-SCP, a user profile database, and a call server such as a Mobile Switching Center (MSC), a Call State Control Function (CSCF), a SIP server, or an H.323 gatekeeper. The IN-SCP includes at least one CPL script that generates a first call-control instruction when executed, means for executing the CPL script in response to receiving a service trigger for the script, and communication means for receiving the service trigger from the call server and sending the call-control instruction to the call server. The user profile database stores the service trigger and an identification of the IN-SCP. The call server retrieves the service trigger from the user profile database, sends the service trigger to the IN-SCP, receives the call-control instruction from the IN-SCP, and executes the call-control instruction to provide the service to the user. In another aspect, the present invention is a method of provisioning a service in a telecommunications network having an IN-SCP, a user profile repository such as a Home Location Register (HLR) or Home Subscriber Server (HSS) that stores a user profile, and a network Administrative Entity (AE). The method includes the steps of receiving in the AE, a user-defined Call Processing Language (CPL) script that provides the service when the script is executed, and determining by the AE whether the CPL script can be successfully executed in the network. If so, the user profile in the user profile repository is modified to include a service trigger for the CPL script, and the verified CPL script is stored in the IN-SCP.

In yet another aspect, the present invention is a method of providing a service to a user in a telecommunications network having an IN-SCP, a user profile repository that stores a user profile, and a call server that controls calls to and from the user. The method includes the steps of storing a user-defined CPL script in the IN-SCP that generates call-control instructions when the script is executed; receiving in the IN-SCP, a service trigger for the script from the call server; and executing the CPL script in response to receiving the service trigger for the script. The call-control instructions are then sent to the call server where they are executed to provide the service to the user.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a simplified block diagram of the preferred embodiment of the Intelligent Network Service Control Point (IN-SCP) of the present invention;

FIG. 2 is a flow chart illustrating the steps involved in provisioning a CPL service according to the teachings of the present invention; and

FIG. 3 is a flow chart illustrating the steps involved in executing a CPL service according to the teachings of the present invention.

### DETAILED DESCRIPTION OF EMBODIMENTS

The present invention implements CPL-defined services in an IN node. The same network node can be used to execute the services in the circuit-switched domain. This can have an important advantage as networks evolve from purely circuit-switched to purely packet-switched networks. For a significant period of time, IN and SIP will co-exist in hybrid networks. While service providers are developing and deploying the new generation of wireless networks based on SIP, they will still have some areas of the world where the networks use the legacy GSM or TDMA circuit-switched technology. It is desirable to execute services in a circuit-switched network that are defined in the multi-media Internet Protocol (IP) domain using CPL. The present invention provides this capability by modifying an IN node such as an IN-SCP to interpret and execute CPL scripts that are loaded into it. The invention thus enables IN-SCPs to handle CPL scripts in the context of IP telephony without changing their existing interfaces toward the IP telephony network (e.g., Intelligent Network Application Part (INAP) over Signaling System 7 (SS7) or over IP).

The present invention also provides the capability to execute multi-media IP services when one party to a call is separated from the other party by an area where the service provider has no multi-media network based on SIP. The user may utilize a PC to define his CPL script that is intended to be executed in the Internet domain using SIP. However, the script is then loaded in an SCP. Then, even if calls are routed through the legacy circuit-switched network, the services can still be executed.

The invention adds the power of IN services to the user's CPL scripts that are defined for specific needs. It gives the user the flexibility to define some of his own services while operating in the circuit-switched domain—a flexibility he never had before.

The CPL scripts define call setup procedures, and each script defines whether it is for originating or terminating calls. In other words, a particular script may be executed when the user originates a call, and another script may be executed when the user receives a call. The scripts are executed before call setup is completed. There are specific triggers in IN that trigger either originating or terminating scripts to be executed. The triggers are defined in the various specifications for the different types of IN networks (Fixed IN, Camel, WIN, etc.). For example, in WIN, the trigger for originating calls is known as “ALLCALLS”.

Since CPL is based on XML, a language used for describing hypertext for Web pages, it is textual; the user can define services in relatively simple semantics. Graphical tools can also be utilized to construct scripts by dragging and dropping Icons. In the Internet domain, the scripts are interpreted and executed on a SIP server. The scripts may be sent to the server in several ways, including e-mail, or by including the scripts as an attachment to a registration message. Because scripts can direct a user's telephone calls, the method by which scripts are transmitted from a client to a server must be authenticated.

### Service Provisioning

Service provisioning includes several steps: (1) loading the CPL script in an IN-SCP (e-mail, attached to registration message, etc.); (2) determining whether the script is an originating or terminating script; and (3) modifying the user profile in a user profile repository such as the user's Home Location Register (HLR) or Home Subscriber Server (HSS). The profile is modified to define new originating and/or terminating triggers required for the call server to request the IN-SCP to execute the script. The call server may be, for example, an MSC, a CSCF, a SIP server, an H.323 gatekeeper, or a Media Gateway Controller that enables calls to pass from the circuit-switched domain to the IP multi-media domain, depending on the configuration of the telecommunications network. The CPL script may be provided first to an Administrative Entity (AE) of the service provider that introduces the new trigger in the HLR and then provides the script to the IN-SCP. The modification of the user profile may include an indication of which IN-SCP is to execute the service. If the user already has some IN services defined in an IN-SCP, the same IN-SCP will normally be identified. The CPL scripts are text-based scripts that are protocol-independent.

Each CPL script corresponds to one originating or terminating trigger. Specific triggers must be defined for each CPL script because the scripts must be started at very specific times in the call in order to integrate the scripts into the IN service-provisioning scheme. The triggers are required because the call setup requires action on the part of the call server to request the IN-SCP to execute the service (CPL script). The call server can only determine general characteristics of a call (such as an 800 number or a call requiring only 4 digits), but cannot make decisions on specific calls such as calls from a specific number. Thus, a trigger such as ALLCALLS causes the call server to query the IN-SCP whenever any call is received for the user. The IN-SCP then determines the action to be taken based on service logic stored within the IN-SCP. However, if the user already has an IN service that requires the same trigger, the corresponding trigger for a particular CPL script may already be defined in the user profile. In this case, the user profile does not have to be modified with the trigger information.

It should be recognized, however, that the IN trigger may cause more than one service to be executed. The trigger may cause one or more IN services defined in the SCP by the service provider to be executed along with the user-defined CPL script. Logic therefore must be included in the SCP that defines the order in which the services should be executed. In the preferred embodiment, this logic is implemented in a Service Interaction Manager (SIM) that manages the interactions between the classic IN services and the CPL services. A CPL script interpreter is also added to the SCP.

Since IN services may be restrictive, or may impact charging or security, they are performed first, and then the CPL scripts are performed. The job of the SIM is simplified if IN services always take precedence over the user-defined CPL services. In this way, when a trigger such as ALLCALLS is received, any service provider-defined WIN services that are triggered are executed first. Then, the user-defined CPL service is executed if it is still needed, and it is consistent with the service provider-defined WIN services.

As an example, when Trigger-1 is received in the IN-SCP for a call to or from User-A, the IN-SCP checks a database and determines that when Trigger-1 is received for User-A, a defined list of services can be performed, some of which may be IN service logic (SL) and some of which may be CPL scripts. If there are no IN services, the IN-SCP immediately performs the CPL script. If there are IN services, the list may include, for example SL1, SL2, and CPL 1. The IN-SCP proceeds to perform SL1 and SL2 as normal, and then determines whether to perform the CPL script. If the service defined by the CPL script has already been performed during the execution of the IN services, or if the CPL script is inconsistent with the IN services, the CPL script is ignored. If the CPL script has not been performed and is consistent with the IN services, the SCP executes the CPL script.

An example that illustrates the necessity to perform particular services first, for compatibility, is when the user has both Call Forwarding Unconditional and Incoming Call Screening services. The order in which these services are performed is important. Call Screening must be performed first or else undesired calls will be forwarded instead of screened. Therefore, if a user wants to write a CPL script for Call Screening, he should not subscribe to a service provider-defined Call Forwarding Unconditional service since the service provider-defined service will be performed first. Instead, the user should also write a script for Call Forwarding that will be executed after the calls are screened.

Several things are important to consider when mapping CPL scripts into the IN service-provisioning scheme. First, the types of decisions made by the logic of the CPL scripts must be considered. When the logic makes a decision, the decision must be communicated to the call server in a way that the call server can understand, and that triggers the call server's follow-on action. In IN, a reason is provided to the call server for each decision since follow-on actions taken by the call server depend on the reason given. In the CPL scripts, there are three types of decisions that can be made regarding how the call is to be handled. A first type known as “Proxy” allows the call setup process to continue. A second type known as “Redirect” changes the number to which the call is directed. A third type known as “Reject” cancels the call. IN service logic also makes these same types of decisions, so in the present invention, the CPL decisions are translated directly into one instruction from the SCP to the call server, and the reason for the decision is included since follow-on actions taken by the call server depend on the reason given.

A second important consideration when mapping CPL scripts into the IN service-provisioning scheme is the manner in which the decisions are made by the logic of the CPL scripts. The CPL scripts generally perform some logic using data provided, and then make a decision such as Proxy (continue), and then wait for specific events related to the call. IN also executes service logic in this manner. The example below is a CPL script taken from the IETF Draft Specification for CPL dated Jul. 14, 2000 and entitled, “CPL: A Language for User Control of Internet Telephony Services”, which is hereby incorporated in its entirety herein. This example is a complex example that illustrates the level of sophisticated behavior that can be achieved by combining CPL scripts. In this example, the user attempts to have his calls reach his desk; if he does not answer within a small amount of time, calls from his boss are forwarded to his cell phone, and all other calls are directed to voice mail.

<cpl>

<subaction id=“voicemail”>

<location url=“sip:jones@phone.example.com”>

<redirect />

</location>

</subaction>
<incoming>

<location url=“sip:jones@phone.example.com”>

<proxy timeout=“8”>

<busy>
<noanswer>

<address-switch field=“origin”>

<address contains=“boss@example.com”>

<location url=“tel:+19175551212”>

<proxy />

</location>

</address>
<otherwise>

<sub ref=“voicemail” />

</otherwise>

</address-switch>

</noanswer>

</proxy>

</location>

</incoming>

</cpl>

The script is executed until proxy timeout which requires the IN-SCP to issue a comment to continue with the call, and to require an event to be provided by the call server that would change the decision (for example, the called party is busy or there is no answer). In WIN, this corresponds to the dynamic arming of detection points in the call. Thus, the IN-SCP instructs the call server to arm particular detection points corresponding to the decision that has been made. If the detection events occur, the script resumes at that point. Thus, the semantics of the CPL scripts may be mapped precisely to the behavior of the IN-SCP.

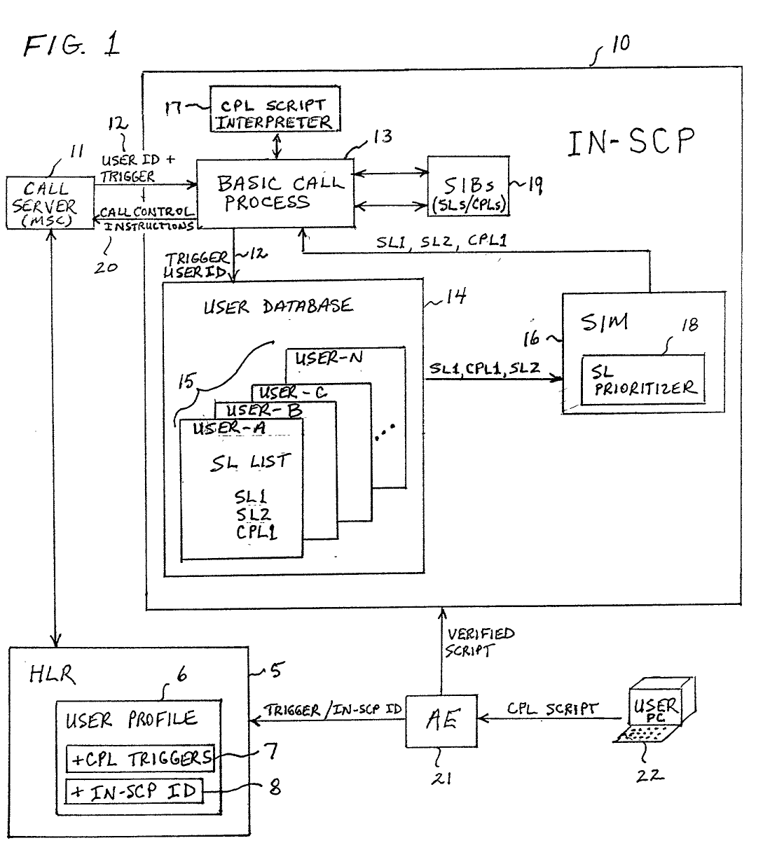

FIG. 1 is a simplified block diagram of the preferred embodiment of the IN-SCP 10 of the present invention. The IN-SCP interacts with a call server 11 to provide services to end users. When a call is originated by a user, or a terminating call is received by a user, the call server requests location information and user information from a user profile repository such as the user's HLR 5. The user profile 6 within the HLR is modified to include the originating and terminating triggers 7 associated with user-defined services written by the user in CPL scripts, and stored in the IN-SCP. The identity 8 of the particular IN-SCP where the CPL scripts are stored is also included in the user profile. As a result of the query from the call server, the HLR returns an instruction for the call server to query the IN-SCP 10 for call-control instructions.

Within the IN-SCP is a Basic Call Process (BCP) 13 that receives a User Identity (User ID) and a trigger 12 from the call server related to a specific call event. For the User ID and trigger received, a user database 14 is accessed to retrieve a service logic (SL) list for the 5 identified user from a plurality of lists 15. For example, for User-A, a list may be retrieved that includes SL1, SL2, and CPL1. The BCP also interacts with a CPL script interpreter 17 when executing CPL scripts.

The SL list is passed to a Service Interaction Manager (SIM) 16 which includes an SL Prioritizer 18. As a general rule, the SL Prioritizer determines that IN SLs are to be executed prior to CPL scripts. The SL list is then passed to the BCP 13 in priority order of execution. The BCP interacts with a database of Service Independent Building Blocks (SIBs) 19 and the CPL script interpreter 17 to perform the required services. The term SIB is used herein to represent both IN service logic and CPL scripts that may be stored in the IN-SCP 10. When the service logic and CPL scripts are executed, the result is call-control instructions 20 that are then passed to the call server 11.

A network Administrative Entity (AE) 21 may be utilized by the service provider to initially provision the user-defined CPL services. When a user creates a CPL script using, for example, a PC 22, the script may be sent to the AE for verification and loading. Verification may include verifying that the script is well-formed and that it can be successfully executed. Once verified, the AE modifies the user profile 6 in the HLR 5 to include the originating or terminating trigger 7 for each script as well as the IN-SCP ID 8 for the IN-SCP where the script is to be loaded. The AE then sends the CPL script to the IN-SCP 10 where it is stored in the SIB database 19. The user database 14 is updated to include the CPL script in the user's information.

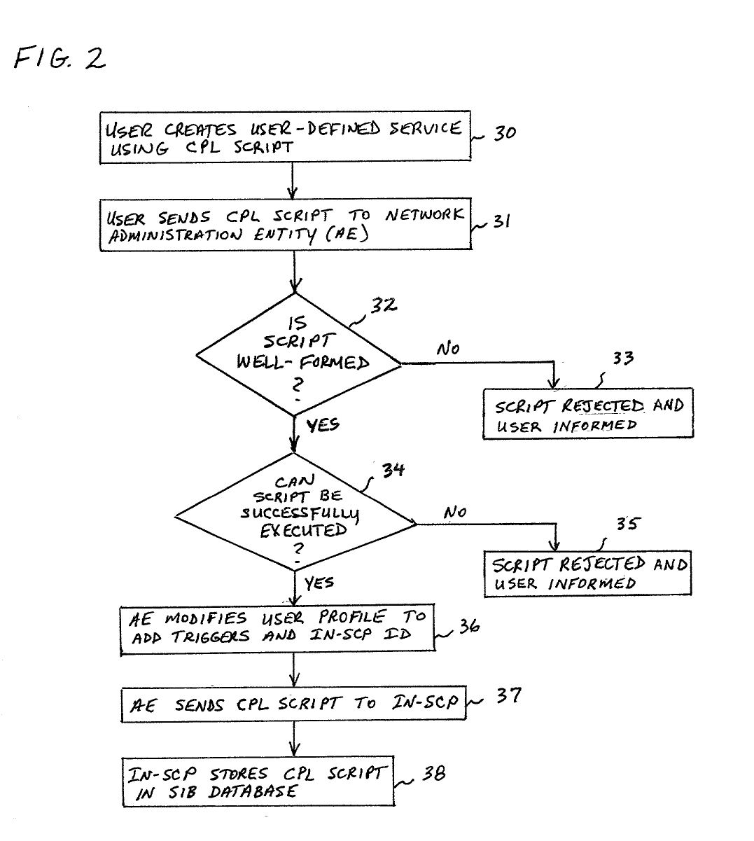

FIG. 2 is a flow chart illustrating the steps involved in provisioning a CPL service according to the teachings of the present invention. At step 30, the user creates a user-defined service using a CPL script. The user can define services in relatively simple semantics, or can use graphical tools that provide a user-friendly interface. At step 31, the user sends the CPL script to the network AE 21. The script may be sent in any suitable manner such as by e-mail or as an attachment to a registration message. At step 32, it is determined whether or not the script is well-formed. Since the script is written by the user, the service provider should verify that the script is well-formed at the time the script is submitted. If it is not well-formed, the script is rejected at step 33, and the user is informed so that the script can either be corrected and resubmitted or abandoned.

If the script is well-formed, the process moves to step 34 where it is determined whether or not the script can be successfully executed. Once again, it is important that the operation of the script be verified at the time the script is submitted, as discovering problems during execution can lead to a user not being able to place or receive calls. This verification should determine that the script can be executed in a finite amount of time (i.e., no generalized looping or non-timed calls to external services), that no unsafe actions such as modifying other users' data are being executed, and that execution of the script does not interfere with the operation of the IN-SCP or other network nodes by using excessive CPU time, memory, network bandwidth, or other resources. If the script cannot be successfully executed, the script is rejected at step 35, and the user is informed so that the script can either be corrected and resubmitted or abandoned. The verification steps 32 and 34 may be performed at any suitable location in the network, but preferably in the AE.

If the script can be successfully executed, the process moves to step 36 where the AE modifies the user's profile 6 in a user profile repository such as HLR 5 to add the originating or terminating triggers 7 for the CPL service, and to add the ID 8 of the IN-SCP where the CPL script is stored. At step 37, the AE sends the CPL script to the IN-SCP, and at 38, the IN-SCP stores the CPL script in the SIB database 19 with its other service logic.

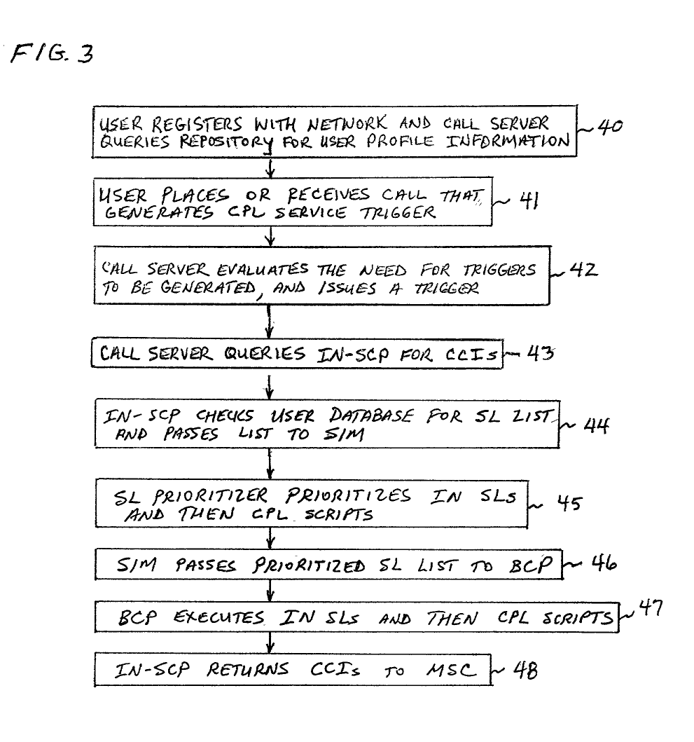

FIG. 3 is a flow chart illustrating the steps involved in executing a CPL service according to the teachings of the present invention. At step 40, a user registers with the network, and the call server 11 queries the user profile repository such as HLR 5 for user profile information. At 41, the user places or receives a call of the type that generates a CPL service trigger. If service triggers have not previously been retrieved, the call server retrieves them at this point. The call server receives the call, evaluates the need for triggers to be generated based on the user profile, and generates a trigger at 42.

At step 43, the call server sends a query for call-control instructions (CCIs) to the IN-SCP 10 and includes the identity of the user (User ID) and the trigger. At step 44, the IN-SCP checks its user database 14 for a service logic (SL) list associated with the User ID and the trigger, and passes the list to the SIM 16. The list may include both IN SLs and CPL scripts. At 45, the SL prioritizer 18 determines the order in which SLs and CPL scripts are to be executed. In the preferred embodiment, the service provider-defined IN SLs are executed first, and then the user-defined CPL scripts are executed. The SIM then passes the prioritized SL list to the BCP 13 for execution at 46. At 47, the BCP executes the SLs and CPL scripts from the SIB database 19. The CPL script interpreter 17 is used to interpret the CPL scripts. The BCP then returns CCIs to the call server at step 48. Execution of the SLs and CPL scripts may be temporarily halted if the logic dictates an action by an external service. Execution of the SL or script is resumed when the action is completed and a continuation trigger is received.

It is thus believed that the operation and construction of the present invention will be apparent from the foregoing description. While the IN-SCP, system, and method shown and described has been characterized as being preferred, it will be readily apparent that various changes and modifications could be made therein without departing from the scope of the invention as defined in the following claims.

What is claimed is:

1. An Intelligent Network Service Control Point (IN-SCP) for providing services to users in a telecommunications network, said IN-SCP comprising:
at least one Call Processing Language (CPL) script that generates a call-control instruction when the script is executed; and
means for executing the CPL script in response to receiving a service trigger for the script.

2. The IN-SCP of claim 1 wherein the CPL script is defined by the user, and the IN-SCP includes a CPL script interpreter for mapping semantics of the CPL script to IN procedural detection points.

3. The IN-SCP of claim 2 further comprising at least one block of service provider-defined IN service logic that provides at least one service when executed.

4. The IN-SCP of claim 3 further comprising:
a user database that stores, for each user, a list of IN service logic and CPL scripts that are to be executed for each service trigger that is received by the IN-SCP; and
a service logic prioritizer that determines an order in which the IN service logic and the CPL scripts are to be executed.

5. A system in a telecommunications network for providing services to users, said system comprising:
an Intelligent Network Service Control Point (IN-SCP), said IN-SCP comprising:
at least one Call Processing Language (CPL) script that generates a first call-control instruction when executed;
means for executing the CPL script in response to receiving a service trigger for the script; and
communication means for receiving the service trigger from a call server and sending the call-control instruction to the call server;
a user profile database that stores the service trigger; and
a call server that retrieves the service trigger from the user profile database, sends the service trigger to the IN-SCP, receives the call-control instruction from the IN-SCP, and executes the call-control instruction to provide the service to the user.

6. The system of claim 5 wherein the CPL script is defined by the user, and the IN-SCP includes a CPL script interpreter for mapping semantics of the CPL script to IN procedural detection points.

7. The system of claim 6 wherein the IN-SCP also includes at least one block of service provider-defined IN service logic that provides a second call-control instruction when executed.

8. The system of claim 7 wherein the IN-SCP also includes:
a user database that stores, for each user, a list of IN service logic and CPL scripts that are to be executed for each service trigger that is received by the IN-SCP; and
a service logic prioritizer that determines an order in which the IN service logic and the CPL scripts are to be executed.

9. The system of claim 5 wherein the CPL script is defined by the user, and the system further comprises a network administrative entity that verifies the CPL script and sends the verified script to the IN-SCP.

10. The system of claim 9 wherein the administrative entity also determines the service trigger for the CPL script and sends the service trigger to the user profile database.

11. A method of provisioning a service in a telecommunications network having an Intelligent Network Service Control Point (IN-SCP), a user profile repository that stores a user profile, and a network Administrative Entity (AE), said method comprising the steps of:
receiving in the AE, a user-defined Call Processing Language (CPL) script that generates a call-control instruction when the script is executed;
determining by the AE whether the CPL script can be successfully executed in the network; and
upon determining that the CPL script can be successfully executed in the network:
modifying the user profile in the user profile repository to include a service trigger for the CPL script; and
storing the verified CPL script in the IN-SCP.

12. The method of claim 11 further comprising rejecting the script upon determining that the CPL script cannot be successfully executed in the network.

13. The method of claim 12 further comprising, before the step of determining whether the CPL script can be successfully executed in the network, the step of determining by the AE whether the CPL script is well-formed.

14. The method of claim 13 further comprising rejecting the script upon determining that the CPL script is not well-formed.

15. The method of claim 11 further comprising, upon determining that the CPL script can be successfully executed in the network, modifying the user profile in the user profile repository to include an identification of the IN-SCP where the CPL script is stored.

16. A method of providing a service to a user in a telecommunications network having an Intelligent Network Service Control Point (IN-SCP), a user profile repository that stores a user profile, and a call server that controls calls to and from the user, said method comprising the steps of:
storing a user-defined Call Processing Language (CPL) script in the IN-SCP, said script generating at least one call-control instruction when the script is executed;
receiving in the IN-SCP, a service trigger for the script from the call server;
executing the CPL script in response to receiving the service trigger for the script;
sending the call-control instruction to the call server; and
executing the call-control instruction by the call server to provide the service to the user.

17. The method of claim 16 further comprising, before the step of executing the CPL script, mapping semantics of the CPL script to IN procedural detection points.

18. The method of claim 17 further comprising the steps of:
determining whether the IN-SCP also stores service provider-defined IN service logic for the user; and
upon determining that the IN-SCP also stores IN service logic for the user, executing the service provider-defined IN service logic before executing the user-defined CPL script.

19. The method of claim 18 wherein the call server retrieves user profile information from the user profile repository when the user registers with the network, and the method further comprises, after the step of storing the user-defined CPL script in the IN-SCP, the steps of:
receiving a call in the call server that is associated with the user;
determining by the call server whether a service trigger is to be generated; and
sending a request for call-control instructions from the call server to the IN-SCP, said request including an identification of the user and the service trigger.

20. The method of claim 19 further comprising, after the step of receiving the service trigger in the IN-SCP, the steps of:
retrieving a service logic (SL) list from a user database in the IN-SCP; and
prioritizing the service provider-defined IN service logic and the user-defined CPL script.

21. The method of claim 20 wherein the step of prioritizing the service provider-defined IN service logic and the user-defined CPL script includes prioritizing the service provider-defined IN service logic and the user-defined CPL script in a Service Interaction Manager (SIM) in the IN-SCP.

22. The method of claim 20 further comprising, after the step of prioritizing the service provider-defined IN service logic and the user-defined CPL script, the steps of:
determining whether the service provider-defined IN service logic and the user-defined CPL script are consistent; and
ignoring the user-defined CPL script if it is inconsistent with the service provider-defined IN service logic.
